(19) United States
(12) Patent Application Publication
(10) Pub. No.: US 2016/0365686 A1
(43) Pub. Date: Dec. 15, 2016

(54) CABLE TV COAXIAL VIDEO AND NETWORK TRANSMITTER AND INSERTION SEAT THEREOF

(71) Applicant: LANTEK ELECTRONICS INC., NEW TAIPEI CITY (TW)

(72) Inventor: Shan-Jui LU, New Taipei City (TW)

(21) Appl. No.: 14/947,895

(22) Filed: Nov. 20, 2015

(30) Foreign Application Priority Data
Jun. 11, 2015 (TW) 104209329

(51) Int. Cl. H01R 25/00; H01R 24/38

(52) U.S. Cl. CPC H01R 25/006; H01R 24/38; H01R 2107/00

(57) ABSTRACT

A cable TV coaxial video and network transmitter includes: a top cover, a connection guiding seat, and a bottom cover; wherein two sides defined on the bottom surface of the connection guiding seat are protruded with a pair of conductive pins, the interior of the bottom cover is installed with a printed circuit board on which two insertion seats corresponding to the two conductive pins are installed, the insertion seat include a clipping member having two sides formed with a pair of connection legs with the upper portion formed with a pair of clamping segments, and a hollow zone is defined to be below bottom edges of the pair of clamping segments and between the pair of connection legs, so the contact length and the contact area between the pair of clamping segment and the conductive pins are able to be determined according to the hollow zone.

### BACKGROUND OF THE INVENTION

1. Field of the Invention

The present invention relates to a cable TV coaxial video and network transmitter, especially to a cable TV coaxial video and network transmitter capable of extending and improving the quality of RF signals provided by a cable TV system.

2. Description of Related Art

A cable TV system is to utilize a signal transmitting cable to transmit the signals emitting by each channel and gathered by a base station to each client, because the base station and the clients are in a one to multiple relation, and there are certain distances between the base station and each of the clients, a cable TV coaxial video and network transmitter (such a multi-tap, a distributor and an adaptor) is required to prevent the signals from attenuating during the long-distance transmitting process and to handle issues such as signal distributing and adapting, so objectives of connecting each client and stabilizing the signal transmission can be achieved.

Take the Taiwan Utility Patent NO. 424992 for instance, when a conductive sleeve served as an insertion seat is inserted in a conductive post of a conductive seat, the contact length between the two is 6 mm to 8 mm. As shown in FIG. 1, when the conductive post is inserted in the conductive sleeve, the return loss at the input end and at the output end with the frequency being in 1002 MHz is higher than the baseline, so the transmitting quality for the RF signals would be affected.

At present, the bandwidth provided by the cable TV system is between 5 MHz to 1002 MHz; and the desire of increasing the bandwidth is limited by the natural characteristic differences between active and passive components inside the cable TV coaxial video and network transmitter, thereby not being able to be achieved. As such, services which can be provided by a cable TV company are restrained by the bandwidth.

In view of the bandwidth of the conventional transmitter not being able to be increased, how to increase the current frequency between 5 MHz to 1002 MHz to between 5 MHz to 1218 MHz for providing more services such as more channels, telecommunication, internet service and satellite signals are a serious issue to be concerned by the skilled people in the art.

### SUMMARY OF THE INVENTION

One primary objective of the present invention is to provide a cable TV coaxial video and network transmitter (such as a multi-tap), in which an insertion seat installed therein is improved, so after the insertion seat allows a conductive pin of a connection guiding seat to be inserted, the contact length and the contact area between the insertion seat and the conductive pin are able to be reduced for enabling the bandwidth of the cable TV coaxial video and network transmitter to be increased and ensuring the quality of RF signals provided by a cable TV system.

For achieving said objective, one technical solution provided by the present invention is to provide a cable TV coaxial video and network transmitter, which includes: a top cover, having a signal input port and a signal output port at two peripheral positions thereof; a connection guiding seat, fastened inside the top cover, wherein two opposite sides thereof are formed with a pair of first openings, and the pair of first openings are respectively adjacent to the signal input port and the signal output port, and two sides defined on the bottom surface of the connection guiding seat are longitudinally protruded with a pair of conductive pins; a bottom cover, combined with the bottom end of the top cover for forming a sealed status, wherein the interior of the bottom cover is installed with a printed circuit board, and the bottom surface of the bottom cover is formed with a plurality of output connectors coupled to the printed circuit board; and two insertion seats, fastened on the printed circuit board corresponding to the two conductive pins, wherein each of the insertion seats includes an elastic clipping member, two sides of the clipping member are formed with a pair of connection legs respectively fastened on the printed circuit board, the upper portions of the pair of connection legs are respectively and integrally formed with a pair of arc-shaped clamping segments allowing each of the conductive pins to be inserted, and a hollow zone is defined to be below bottom edges of the pair of clamping segments and between the pair of connection legs, so the contact length and the contact area between the pair of clamping segment and each of the conductive pins are able to be determined according to the hollow zone.

Another objective of the present invention is to provide an insertion seat of a cable TV coaxial video and network transmitter, in which the structure thereof is improved, so after the insertion seat allows a conductive pin of a connection guiding seat to be inserted, the contact length and the contact area between the insertion seat and the conductive pin are able to be reduced for enabling the bandwidth of the cable TV coaxial video and network transmitter to be increased and ensuring the quality of RF signals provided by a cable TV system.

For achieving said objective, one technical solution provided by the present invention is to provide an insertion seat of a cable TV coaxial video and network transmitter, which includes: an elastic clipping member, wherein two sides thereof are formed with a pair of connection legs, the upper portions of the pair of connection legs are respectively and integrally formed with a pair of arc-shaped clamping segments allowing a conductive pin to be inserted, and a hollow zone is defined to be below bottom edges of the pair of clamping segments and between the pair of connection legs, so the contact length and the contact area between the pair of clamping segment and the conductive pin are able to be determined according to the hollow zone.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view illustrating the return loss at the input end and at the output end of a conventional cable TV coaxial video and network transmitter.

FIG. 2 is a perspective exploded view illustrating the cable TV coaxial video and network transmitter according to the present invention;

FIG. 3 is a perspective exploded view illustrating the insertion seat according to the present invention;

FIG. 4 is a perspective view illustrating the assembly of the cable TV coaxial video and network transmitter and a signal transmitter connector;

FIG. 5 is a cross sectional view of FIG. 4 taken along line A-A;

FIG. 6 is a cross sectional view illustrating the conductive pin being inserted in the insertion seat according to the present invention; and

FIG. 7 is a schematic view illustrating the return loss at the input end and at the output end of the cable TV coaxial video and network transmitter according to the present invention.

### DETAILED DESCRIPTION OF THE PREFERRED EMBODIMENT

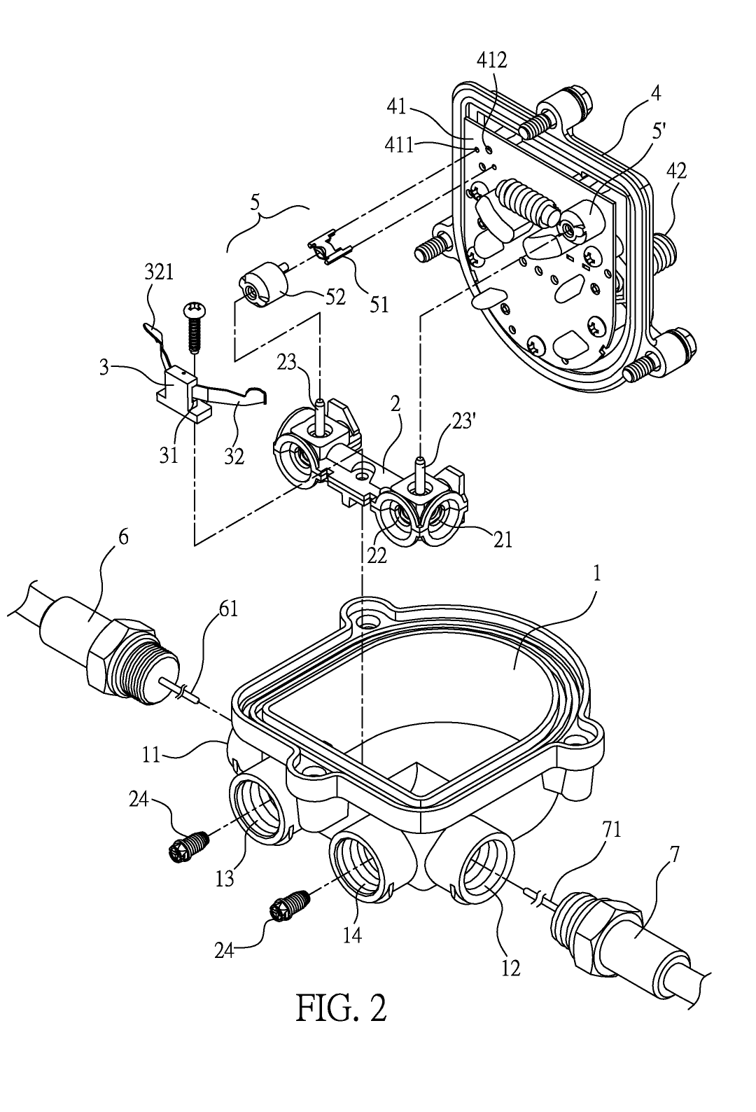

Referring from FIG. 2 to FIG. 6, the present invention provides a cable TV coaxial video and network transmitter (such as a multi-tap), which includes a top cover 1, a connection guiding seat 2, an elastic sheet fastening seat 3, a bottom cover 4 and two insertion seats 5.

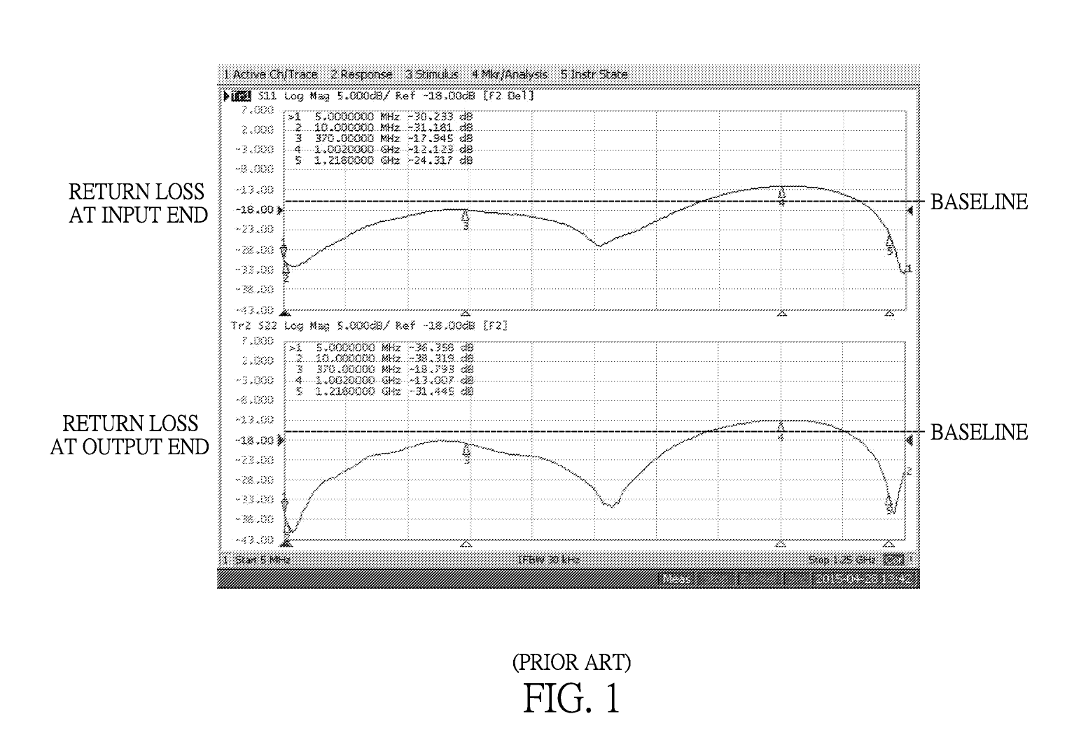

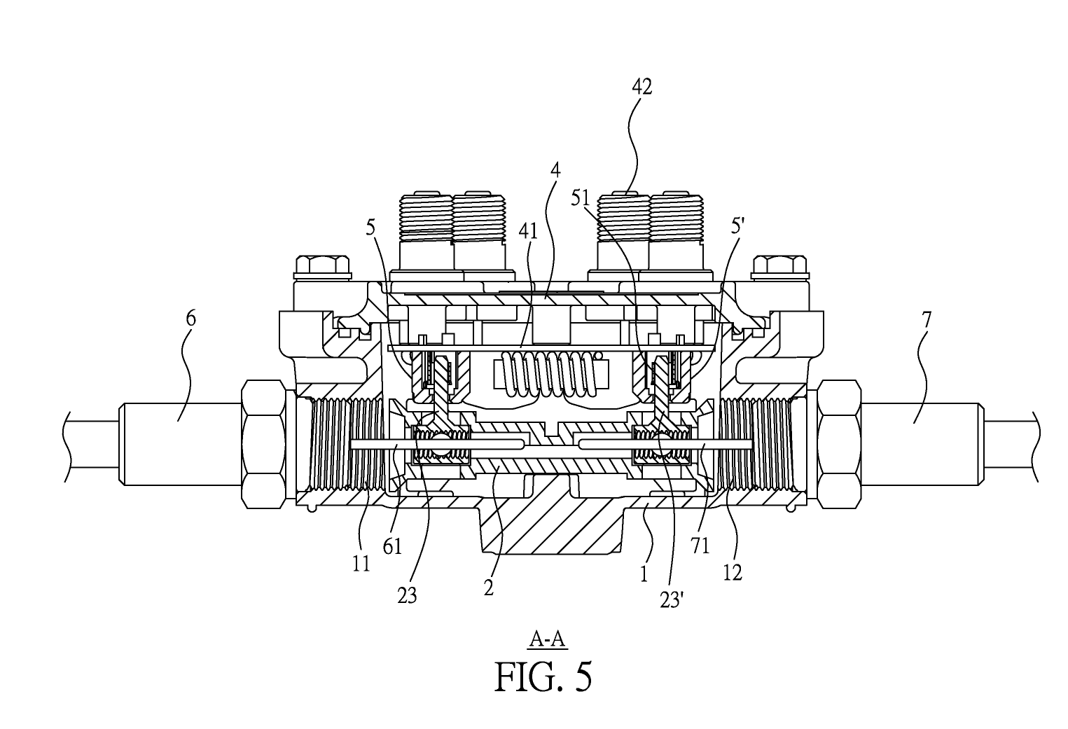

The top cover 1 is formed as a cover member made of an aluminum alloy, and has a signal input port 11 (as shown in FIG. 1 and FIG. 5) and a signal output port 12 at two peripheral positions thereof (such as two opposite sides), and vertical sides of the signal input port 11 and the signal output port 12 are respectively formed with an input locking port 13 and an output locking port 14. As a matter of fact, the input locking port 13 and the output locking port 14 can also be served as a signal input port and a signal output port, and the signal input port 11 and the signal output part 12 are correspondingly served as an input locking port and an output locking port.

The connection guiding seat 2 is fastened on a base formed inside the top cover 1 for receiving signals transmitted by a base station of a cable TV system. Two opposite sides of the connection guiding seat 2 are formed with a pair of first openings 21, the pair of first openings 21 are respectively arranged adjacent to the signal input port 11 and the signal output port 12 which are oppositely arranged. Wherein, vertical sides of the pair of first openings 21 are respectively formed with a second opening 11, and the pair of second openings 22 are respectively arranged adjacent to the input locking port 13 and the output locking port 14 which are adjacently arranged. Wherein, two sides defined on the bottom surface of the connection guiding seat 2 are longitudinally protruded with a pair of conductive pins 23, 23′ capable of transmitting signals.

As such, when the transmitter is used for connection, a signal input connector 6 from the base station and a signal output connector 7 connected to another transmitter are respectively locked in the signal input port 11 and the signal output port 12 at two sides of the top cover 1, so a signal input conducting member 61 of the signal input connector 6 and a signal output conducting member 71 of the signal output connector 7 are enabled to respectively pass each of the first openings 21 at two sides of the connection guiding seat 2 for being respectively inserted in main bodies of the two conductive pins 23, 23′, then two cable securing screws 24 are provided for respectively passing the input locking port 13 and the output locking port 14 of the top cover 1 and the pair of second openings 22 so as to be locked in the main bodies of the two conducive pins 23, 23′, thereby allowing the signal input conducting member 61 and the signal output conducting member 71 to be respectively locked and fastened with the two conductive pins 23, 23′.

In addition, the bottom surface of the connection guiding seat 2 is longitudinally installed with the elastic sheet fastening seat 3, the elastic sheet fastening seat 3 is transversally formed with a recess 31 for allowing a bow-shaped elastic sheet 32 to be accommodated, two ends of the elastic sheet 32 are respectively formed as contact end 321, and the pair of contact ends 321 are connected to the two conductive pins 23, 23′ of the connection guiding seat 2 for forming a signal conducting status.

As such, when the transmitter is in a process of being repaired or maintained, because the contact ends 321 at the two ends of the elastic sheet 32 are respectively connected to the two conductive pins 23, 23′ of the connection guiding seat 2, the signal interrupting status is prevented, and each client can still receive signals transmitted by the base station.

The bottom cover 4 is formed as a cover member made of an aluminum alloy and combined (such as screw-fitted) with the bottom end of the top cover 1, thereby being formed as a sealed shell body. The interior of the bottom cover 4 is installed with a printed circuit board 41, the printed circuit board 41 is installed with two insertion seats 5, 5′ at the locations corresponding to the two conductive pins 23, 23′, and the two insertion seats 5, 5′ allow the two conductive pins 23, 23′ to be inserted, thereby forming a signal conducting status. Moreover, the bottom surface of the bottom cover 4 is formed with a plurality of output connectors 42 coupled to the printed circuit board 41 for transmitting signals to clients.

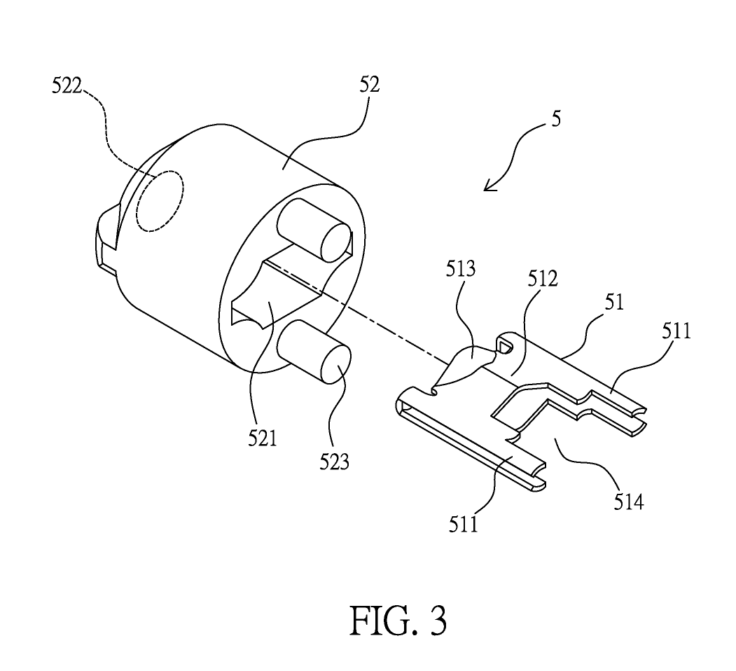

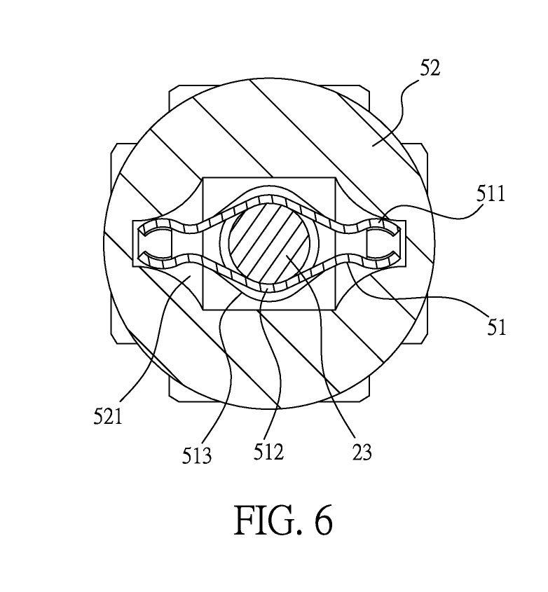

As shown in FIG. 2, FIG. 3, FIG. 5 and FIG. 6, because the structures of the two insertion seats 5, 5′ are totally the same, only the insertion seat 5 at the left side and used for transmitting signals is adopted for illustration. The insertion seat 5 includes an elastic clipping member 51, two sides of the clipping member 51 are formed with a pair of connection legs 511, the pair of connection legs 511 are respectively inserted in connection holes 411 preformed on the printed circuit board 41 and welded thereon for being fastened. The upper portions of the pair of connection legs 511 are respectively and integrally formed with a pair of arc-shaped clamping segments 512 symmetrically arranged and allowing each of the conductive pins 23 to be inserted, the top ends of the pair of clamping segments 512 are formed with a pair of guiding inclined surfaces 513 protruded outwardly, and a hollow zone 514 is defined to be below bottom edges of the pair of clamping segments 512 and between the pair of connection legs 511, so the contact length and the contact area between the pair of clamping segment 512 and each of the conductive pins 23 can be determined according to the dimension design of the hollow zone 514, thereby allowing the bandwidth of the transmitter and the quality of RF signals to be adjusted.

As a matter of fact, the clipping member 51 is made of a metal sheet being punched and bent for forming as a dual-layer rack member, wherein the thickness of the metal sheet is between 0.2 mm to 0.4 mm, the total height thereof is between 8 mm to 10 mm, and the contact length between the pair of clamping segments 512 and the conducive pin 23 is between 2.5 mm to 5 mm, so the following features can be ensured:
(1) The clipping members 51 of the insertion seats 5, 5′ are able to sustain the pulling force applied by the conductive pins 23, 23′, so situations such as loosening and falling can be prevented.
(2) When the RF signals of the cable TV system are transmitted, situations such as the quality of RF signals being poor or even interrupted caused by the insertion seats 5, 5′ and the conducive pins 23, 23′ being in a poor contacting or loosening status can be avoided.
(3) The quality of RF signals having the bandwidth from 5 MHz to 1218 MHz provided by the cable TV system can be ensured.

Moreover, the insertion seat 5 further includes an enclose member 52, the bottom end thereof is formed with an accommodation slot 521 allowing the clipping member 51 to be sleeved and tightly engaged, and the top end thereof is formed with an insertion hole 522 allowing the conductive pins 23, 23′ to be inserted and communicated with the accommodation slot 521 and the pair of guiding inclined surfaces 513 (or the pair of clamping segments 512). The bottom surface of the enclose member 52 is additionally formed with a pair of fasten pieces 523 inserted in board holes 412 preformed on the printed circuit board 41. If the enclose member 52 is made of a metal material, a welding means is adopted for installing and fastening the pair of fasten pieces 523 on the printed circuit board 41. If the enclose member 52 is made of a plastic material, conventional elastic hooks or a thermal melting means can be adopted for installing and fastening the pair of fasten pieces 523 in the pair of board holes 412 of the printed circuit board 41.

As what's mentioned above, the enclose member 52 can be made of a metal material or a plastic material; if the enclose member 52 is made of a metal material, the thickness thereof is between 0.2 mm to 0.4 mm; if the enclose member 52 is made of a plastic material, there is no limitation to the thickness thereof; however, whether the enclose member 52 is made of a metal material or a plastic material, the height thereof must be between 10 mm to 13 mm.

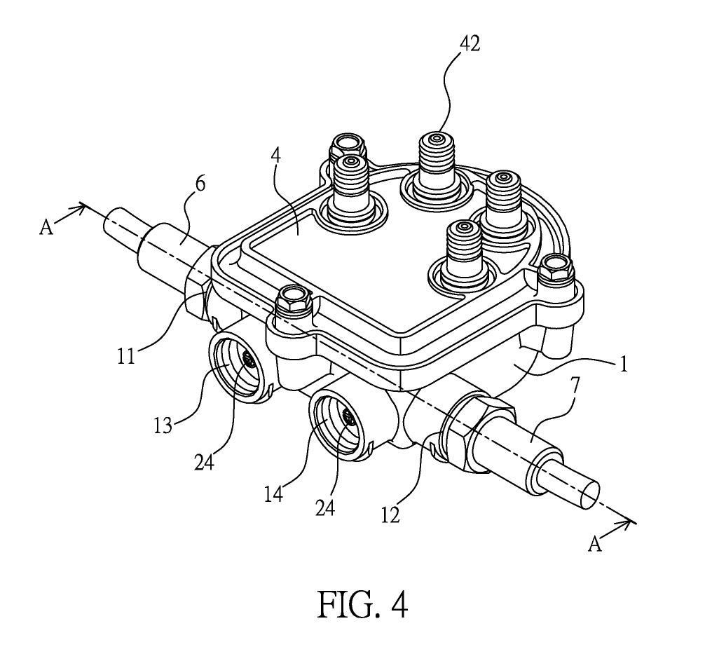

As shown in FIG. 4 and FIG. 5, after the transmitter provided by the present invention is assembled, RF signals provided by the base station of the cable TV system are able to enter the transmitter from the signal input port 11 and through the signal input connector 6 and the signal input conducting member 61, then the signals are transmitted to the printed circuit board 41 through the conductive pin 23 of the connection guiding seat 2 and the clipping member 51 of the insertion seat 5. When the printed circuit board 41 receives the RF signals, the signals are divided into two parts, one part of the RF signals are directly transmitted to the clients through the output connectors 42, the other RF signals are transmitted to another conductive pin 23′ of the connection guiding seat 2 through the clipping member 51 of another insertion seat 5′, then transmitted to the next transmitter through the signal output connector 7 and the signal output conducting member 71.

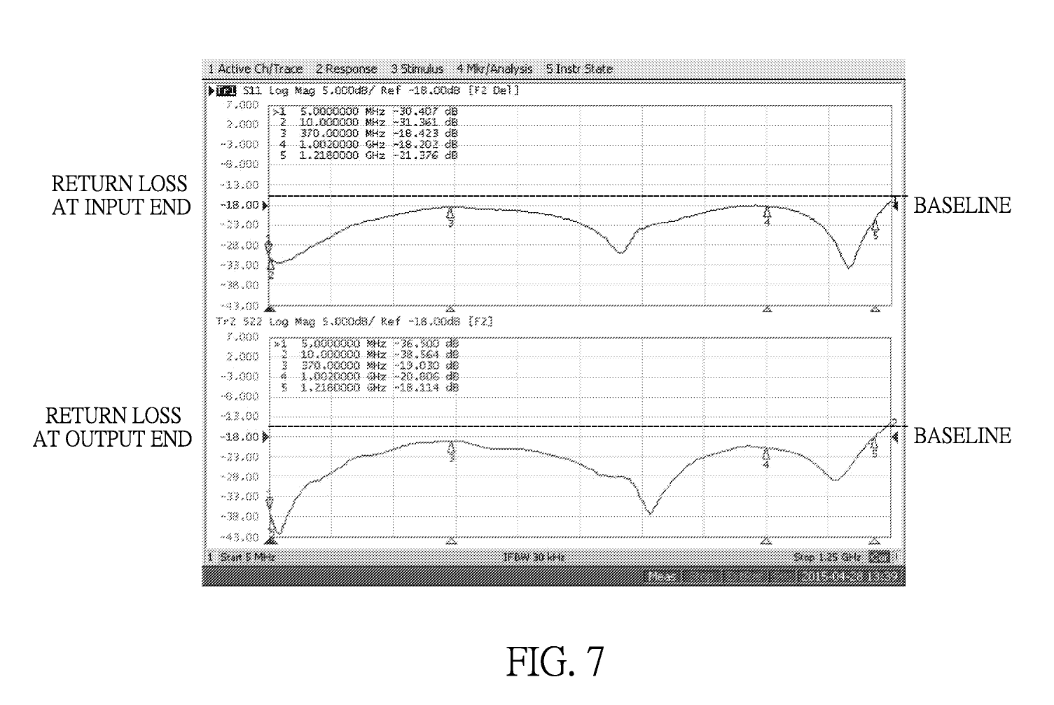

As shown in FIG. 7, when the transmitter is in actual use, the return loss at the input end and at the output end with the frequency between 5 MHz to 1218 MHz is able to be controlled for being under the baseline; as such, with the line shape differences of the return loss at the input end and at the output end disclosed in FIG. 1 and FIG. 7, it is obvious that the contact length and the contact area between the clipping member 51 and the conductive pins 23, 23′ has an affection on the frequency and the quality of RF signals.

Based on what has disclosed above, advantages achieved by the present invention are as followings: the insertion seat is able to be extend and improve the quality of the RF signals having high frequency from 900 MHz to 1218 MHz provided by the cable TV system, so the cable TV system is enabled to increase the current frequency between 5 MHz to 1002 MHz to between 5 MHz to 1218 MHz for providing more services such as more channels, telecommunication, internet and satellite signals; moreover, the insertion seat is able to ensure the contact length and the contact area to be optimal when the conductive pins are inserted, and the electric characteristic of the electronic components on the printed circuit board can be prevented from being altered, and enough contact area is provided for enabling the transmitter to sustain high current (10-12A) and allowing the transmitter not to be damaged by thunder strikes, so the quality of RF signals provided by cable TV system can be ensured. Accordingly, the cable TV coaxial video and network transmitter provided by the present invention is novel and more practical in use comparing to prior arts.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

What is claimed is:

1. A cable TV coaxial video and network transmitter, including:
a top cover, having a signal input port and a signal output port at two peripheral positions thereof;
a connection guiding seat, fastened inside said top cover, wherein two opposite sides thereof are formed with a pair of first openings, and said pair of first openings are respectively adjacent to said signal input port and said signal output port, and two sides defined on the bottom surface of said connection guiding seat are longitudinally protruded with a pair of conductive pins;
a bottom cover, combined with the bottom end of said top cover for forming a sealed status, wherein the interior of said bottom cover is installed with a printed circuit board, and the bottom surface thereof is formed with a plurality of output connectors coupled to said printed circuit board; and
two insertion seats, fastened on said printed circuit board corresponding to said two conductive pins, wherein each of said insertion seats includes an elastic clipping member, two sides of said clipping member are formed with a pair of connection legs respectively fastened on said printed circuit board, the upper portions of said pair of connection legs are respectively and integrally formed with a pair of arc-shaped clamping segments allowing each of said conductive pins to be inserted, and a hollow zone is defined to be below bottom edges of said pair of clamping segments and between said pair of connection legs, so the contact length and the contact area between said pair of clamping segments and each of said conductive pins are able to be determined according to said hollow zone.

2. The cable TV coaxial video and network transmitter as claimed in claim 1, wherein vertical sides of said signal input port and said signal output port are respectively formed with an input locking port and an output locking port; vertical sides of said pair of first openings are respectively formed with a second opening, and said pair of second openings are respectively arranged adjacent to said input locking port and said output locking port; and two cable securing screws are provided for respectively passing said input locking port, said output locking port and said pair of second openings so as to be locked in main bodies of said two conducive pins.

3. The cable TV coaxial video and network transmitter as claimed in claim 1, wherein the bottom surface of said connection guiding seat is longitudinally installed with an elastic sheet fastening seat, said elastic sheet fastening seat is transversally formed with a recess for allowing a bow-shaped elastic sheet to be accommodated, two ends of said elastic sheet are respectively formed as contact end, and said pair of contact ends are connected to said two conductive pins for forming a signal conducting status.

4. The cable TV coaxial video and network transmitter as claimed in claim 1, wherein the top ends of said pair of clamping segments of said clipping member are formed with a pair of guiding inclined surfaces protruded outwardly.

5. The cable TV coaxial video and network transmitter as claimed in claim 1, wherein said clipping member of each of said insertion seat is made of a metal sheet being punched and bent for forming as a dual-layer rack member, wherein the thickness of said metal sheet is between 0.2 mm to 0.4 mm, the total height thereof is between 8 mm to 10 mm, and said contact length between said pair of clamping segments and each of said conducive pins is between 2.5 mm to 5 mm.

6. The cable TV coaxial video and network transmitter as claimed in claim 1, wherein each of said insertion seats further includes an enclose member, the bottom end of said enclose member is formed with an accommodation slot allowing said clipping member to be sleeved and tightly engaged, and the top end thereof is formed with an insertion hole allowing each of said conductive pins to be inserted and communicated with said accommodation slot and said pair of clamping segments, and the bottom surface of said enclose member is additionally formed with a pair of fasten pieces inserted in said printed circuit board.

7. The cable TV coaxial video and network transmitter as claimed in claim 6, wherein said enclose member is made of a plastic material, and the height thereof is between 10 mm to 13 mm.

8. The cable TV coaxial video and network transmitter as claimed in claim 6, wherein said enclose member is made of a metal material, the thickness thereof is between 0.2 mm to 0.4 mm, and the height thereof is between 10 mm to 13 mm.

9. An insertion seat of a cable TV coaxial video and network transmitter, including:
an elastic clipping member, wherein two sides thereof are formed with a pair of connection legs, the upper portions of said pair of connection legs are respectively and integrally formed with a pair of arc-shaped clamping segments allowing a conductive pin to be inserted, and a hollow zone is defined to be below bottom edges of said pair of clamping segments and between said pair of connection legs, so the contact length and the contact area between said pair of clamping segment and said conductive pin are able to be determined according to said hollow zone.

10. The insertion seat of a cable TV coaxial video and network transmitter as claimed in claim 9, wherein the top ends of said pair of clamping segments of said clipping member are formed with a pair of guiding inclined surfaces protruded outwardly.

11. The insertion seat of a cable TV coaxial video and network transmitter as claimed in claim 9, wherein said clipping member is made of a metal sheet being punched and bent for forming as a dual-layer rack member, wherein the thickness of said metal sheet is between 0.2 mm to 0.4 mm, the total height thereof is between 8 mm to 10 mm, and said contact length between said pair of clamping segments and said conducive pin is between 2.5 mm to 5 mm.

12. The insertion seat of a cable TV coaxial video and network transmitter as claimed in claim 9, further including an enclose member, the bottom end of said enclose member is formed with an accommodation slot allowing said clipping member to be sleeved and tightly engaged, and the top end thereof is formed with an insertion hole allowing said conductive pin to be inserted and communicated with said accommodation slot and said pair of clamping segments, and the bottom surface of said enclose member is additionally formed with a pair of fasten pieces.

13. The insertion seat of a cable TV coaxial video and network transmitter as claimed in claim 12, wherein said enclose member is made of a plastic material, and the height thereof is between 10 mm to 13 mm.

14. The insertion seat of a cable TV coaxial video and network transmitter as claimed in claim 12, wherein said enclose member is made of a metal material, the thickness thereof is between 0.2 mm to 0.4 mm, and the height thereof is between 10 mm to 13 mm.
